(19) United States
(12) Patent Application Publication
(10) Pub. No.: US 2004/0118357 A1
(43) Pub. Date: Jun. 24, 2004

(54) Cat lavatory

(76) Inventor: Dietmar Lange, Vallendar (DE)

Correspondence Address: FULBRIGHT & JAWORSKI, LLP, 1301 MCKINNEY, SUITE 5100, HOUSTON, TX, 77010-3095, US

(21) Appl. No.: 10/471,365

(22) PCT Filed: Feb. 28, 2002
(86) PCT No.: PCT/EP02/02196

(30) Foreign Application Priority Data
Mar. 14, 2001 (DE) 101 12 128.8

(51) Int. Cl. A01K 29/00

(52) U.S. Cl. 119/167

(57) ABSTRACT

A cat lavatory with a lower part and a container holding an absorbent material that can be inserted into the lower part, characterised in that the container comprises a lining layer of non-woven material.

### CROSS-REFERENCE TO RELATED APPLICATIONS

This application is a national stage filing of PCT/EP02/02196 filed Feb. 28, 2002 claiming priority to DE 101 12 128.8 filed Mar. 14, 2001.

### TECHNICAL FIELD

The invention relates to a cat lavatory with a lower part and a replaceable container that can be inserted into the lower part, containing an absorbent material.

### BACKGROUND OF THE INVENTION

It is a well-known fact that cats can easily be trained to deposit urine and faeces in a container provided for that purpose. In a simple embodiment, this container is filled with a porous, absorbent and, advantageously, odour-inhibiting material, known as cat litter. Cat litter needs to be replaced regularly. Cleaning a cat lavatory of this kind is time-consuming and unpleasant, however, since it is possible for the lavatory walls to be soiled or for there to be litter adhering to the lavatory walls. In addition, large amounts of litter need to be disposed of each time, because the litter ought to be 6 to 8 cm (2 to 3 ins.) deep on average, and the amount of litter consumed is, as a rule, greater than is actually necessary. In addition, simply tipping the contents of the cat lavatory into the dustbin or the like is also unhygienic, and problems associated with dust and odours are inevitable in the process.

Cat lavatories are known in the state of the art in which a resealable bag filled with cat litter can be placed into the cat lavatory container. This bag can be sealed after use and disposed of in a simple manner with the household waste.

DE 36 25 528 C2, for example, teaches a cat lavatory consisting of a disposable soft package made of flexible material with a receptacle space which is closed on all sides and contains one hygienic litter filling. So that the package can be used, the top side of the receptacle space can be opened and the top of the package torn open to reveal the contents. After use, the cat lavatory consisting of the disposable soft package can be disposed of in a closed state.

DE 35 39 637 A1 discloses a cat lavatory with a lower part and a replaceable bag filled with cat litter which can be placed in the lower part. The bag here is designed in such a way that the top end portions of the bag can be slipped over the upper peripheral edge of the cat lavatory and attached so that soiling of the lavatory container is avoided. After use, the bag is sealed with the aid of a closure means and the soiled cat litter can be disposed of securely.

A cat lavatory is also known from U.S. Pat. No. 3,771,493, which comprises a container with a liner suitable for insertion into said container in the form, for example, of a polyethylene film. Cat litter is scattered into said liner and, after use, can be removed from the container together with the liner and disposed of.

A disadvantage of the cat lavatories known from the prior art, however, is the extremely high consumption of litter, because the litter in the cat lavatory needs to be sufficiently deep, in particular in order to absorb large quantities of urine and faeces and to prevent soiling of the lavatory walls. The consumption of litter is, as a rule, greater than is really necessary. This in turn involves the cat owner's constantly having to buy and transport heavy sacks of litter, which also involves great effort and expense. Corresponding to the large amount of litter needed, large amounts of litter also need to be disposed of. That, too, involves greater effort and, at times when rubbish disposal charges are high, is likewise very cost-intensive.

The object of the present invention is therefore to develop the generic cat lavatory further such that the disadvantages of the prior art are overcome, especially so that the amount of litter needed is reduced, while at the same time avoiding soiling of lavatory walls or litter adhering to lavatory walls.

### BRIEF SUMMARY OF THE INVENTION

In accordance with the invention, this object is achieved in that the container comprises a lining layer of non-woven material.

In accordance with the invention, it is envisaged that the lining layer of non-woven material should comprise a highly absorbent material.

Preferably, the lining layer of non-woven material comprises an odour-binding material.

In a particularly preferred embodiment, it is envisaged that the lining layer of non-woven material should be scratch-proof, at least on its upper surface.

In accordance with the invention, it is also proposed that the external dimensions of the lining layer of non-woven material should correspond in form substantially to the internal dimensions of the lower part.

It is also preferred, according to the invention, that the lining layer of non-woven material should be between 0.1 and 1 cm thick, preferably 0.5 cm.

In addition, it is proposed that a layer of litter be disposed on the lining layer of non-woven material.

In accordance with the invention, it is further envisaged that the layer of litter should be between 1 and 3 cm, preferably 2 cm, thick.

It is also proposed, according to the invention, that the lower part should be in the shape of an open, rectangular bowl.

In accordance with the invention, it can also be provided for the container to be capable of being opened in such a way that its top extremities, after it is placed in the lower part, can be slipped over the upper peripheral edge of the lower part and, after the period of use is finished, folded together again for resealing.

In this context, it can be provided for the extremity of the container to be attachable to the upper peripheral edge of the lower part.

In addition, one embodiment of the invention is characterised by having an upper part which can be removably placed on the lower part after the extremities of the container have been folded out, said upper part covering the upper peripheral edge of the lower part and securing the folded out extremities of the container on the upper peripheral edge of the lower part.

In accordance with the invention, it is envisaged that the upper part should be designed in the form of a rectangular frame.

A cat lavatory of the invention can also be characterised by having at least one closure means for resealing the container after use.

In this context, it can be provided for the closure means to comprise adhesive strips or a tape.

A further embodiment of the invention is characterised by having a separate storage box for holding a number of containers.

In this context, a cover can be provided on the storage box with an opening for removal.

The container preferably takes the form of a tubular bag.

One embodiment of the invention is characterised by the fact that the tubular bag is vacuum-sealed prior to use.

Finally, in accordance with the invention, it is preferred for the tubular bags to be provided in the storage box in the form of a supply roll and for them to be separable by means of a tearing strip and individually removable via the removal opening.

The invention is thus based on the surprising finding that, by using a highly absorbent lining layer of non-woven material, which is preferably odour-binding and—at least in its upper layer—scratch-proof, in a cat lavatory of the invention, the consumption of litter can be drastically reduced. Because of the special packaging concept for the lining layer of non-woven material, it is not possible for the lavatory walls to be soiled, which considerably simplifies the cleaning of the cat lavatory. Advantageously, when the concept of the invention is used, the consumption of litter is reduced by as much as 60 to 70 per cent, because the liquid is substantially absorbed by the lining layer of non-woven material. The main purpose of the litter, in this case, is merely to satisfy the cat's instinctive need to scratch. Furthermore, the lining layer of non-woven material is considerably lighter than a comparable volume of litter. The amount to be disposed of is also reduced substantially. Using the cat lavatory according to the present invention, reliable feline hygiene can be provided for at least one week with one tubular bag unit.

In a particular embodiment of the cat lavatory of the invention, the provision of a separate storage box for containers or tubular bags, attached to the cat lavatory, facilitates the preparation of the cat lavatory even more, since the containers or tubular bags can be removed individually, straight from a supply roll for example, and placed directly into the lower part of the cat lavatory.

In the cat lavatory of the invention, the container or tubular bag can optionally already comprise cat litter, or, after the lower part of the cat lavatory has been lined with a container comprising merely a lining layer of non-woven material, the cat litter can then be scattered on said lining layer of non-woven material.

The container or tubular hose of the cat lavatory of the invention also makes it possible for it to be attached securely and stably to the lower part of the cat lavatory, thus preventing it from slipping, which might possibly lead to soiling of the walls of the lower part.

It will be apparent that the lavatory of the invention can also be used for a wide variety of other pets.

Because of the low transport weight and volume, it is possible to provide containers or tubular bags for sale in the form of double packs or multi-packs.

Alternatively, there might be provision for the container to comprise a folding pack that forms a packaging container which is stable in shape and which can be unfolded for use and placed in the lower part of the cat lavatory. The advantage of an embodiment of this kind is that the folding pack serves as a (packaging) container for the absorbent liner in the form of the lining layer of non-woven material (with or without a tubular bag surrounding it) and that it can be marketed in this form as a sales unit. For this purpose, it is particularly advantageous if the folding pack is stackable and if it is substantially cuboid in shape. It is convenient for the folding pack to be made from a blank of paper, paperboard, cardboard, light plastic, composite material or some absorbent material which is planar in its initial condition.

The folding pack will preferably have a central, preferably substantially rectangular floor portion, against which preferably rectangular wall portions abut.

It is convenient for there to be corner portions disposed between adjacent wall portions, it being possible for said corner portions to be resting against said wall portions when folded up, so that a substantially cuboid receptacle space for absorbent material is formed.

Abutting the wall or corner portions there will preferably be lid portions. Lid portions will preferably abut both the wall and the corner portions, so that the lid portions overlap one another several times when the folding pack is folded up. It is convenient for the lid portions to be substantially rectangular.

In a preferred further development of the invention, there are handle portions abutting the lid portions. The handle portions can be folded to lie flat on the lid portions or to project away from them. In addition, there can be provision for the handle portions to be designed such that they overlap several times, e.g. four, six or eight times, so that they form a stable handle for the folding pack which is capable of bearing loads and which has no tendency to tear prematurely.

It is convenient for this version too to have at least one closure means for resealing the folding pack after use. For this purpose, it is possible to provide something such as a drawstring (or a piece of elastic or the like), which can, for example, engage through holes provided in the edge portion of the folding pack.

Preferably, the folding pack will be arranged so that it can be folded apart in such a way that its outer edge portion, after being placed in the lower part, can be folded over an upper peripheral edge of the lower part. In this case, said edge portion of the folding pack can be attachable to the upper peripheral edge of the cat lavatory. For this purpose, a top part can be provided which can be removably placed on top of the lower part in order to secure the folded-over edge portion of the folding pack on the upper peripheral edge of the lower part. The top part can be designed in the form of a frame adapted to the shape of the lower part.

### BRIEF DESCRIPTION OF THE DRAWINGS

Further features and advantages of the invention can be learned from the following detailed description, in which two embodiments of the cat lavatory of the invention are explained in detail with reference to drawings, in which:

FIG. 1 shows a perspective view of a cat lavatory of the invention with a tubular bag to be placed in it;

FIG. 2 shows a cross-section through a tubular bag according to the invention in its closed state;

FIG. 3 shows a cross-section through the tubular bag of the invention placed in a container of the cat lavatory, in its opened state;

FIG. 4 shows a perspective view of a cat lavatory of the invention with a tubular bag in its opened state;

FIG. 5 shows a cross-section through the cat lavatory of the invention with an upper part placed on it;

FIG. 6 shows a section of the edge portion of the cat lavatory of the invention from FIG. 5;

FIG. 7 shows a perspective, exploded view of the cat lavatory of the invention with the upper part;

FIG. 8 shows a perspective view of the assembled cat lavatory of the invention in use;

FIGS. 9a, 9b show perspective views illustrating how to dismantle the cat lavatory and remove the tubular bag;

FIG. 10 shows a second embodiment of the cat lavatory of the invention in an exploded view;

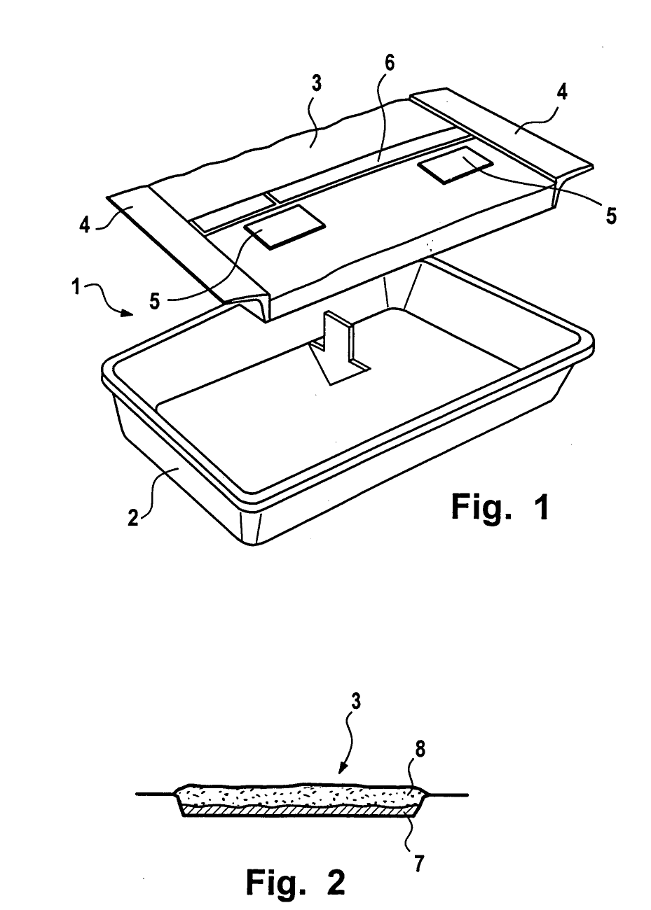

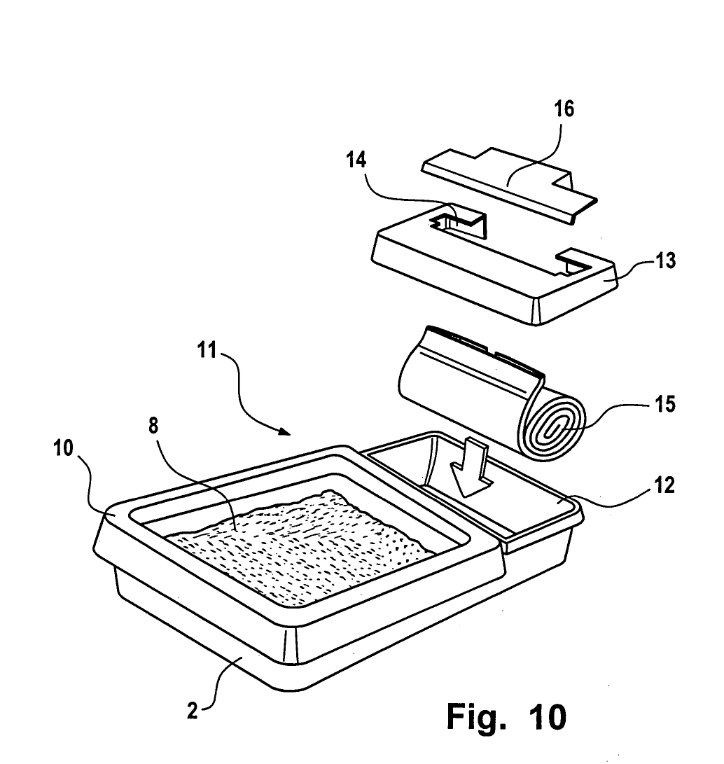

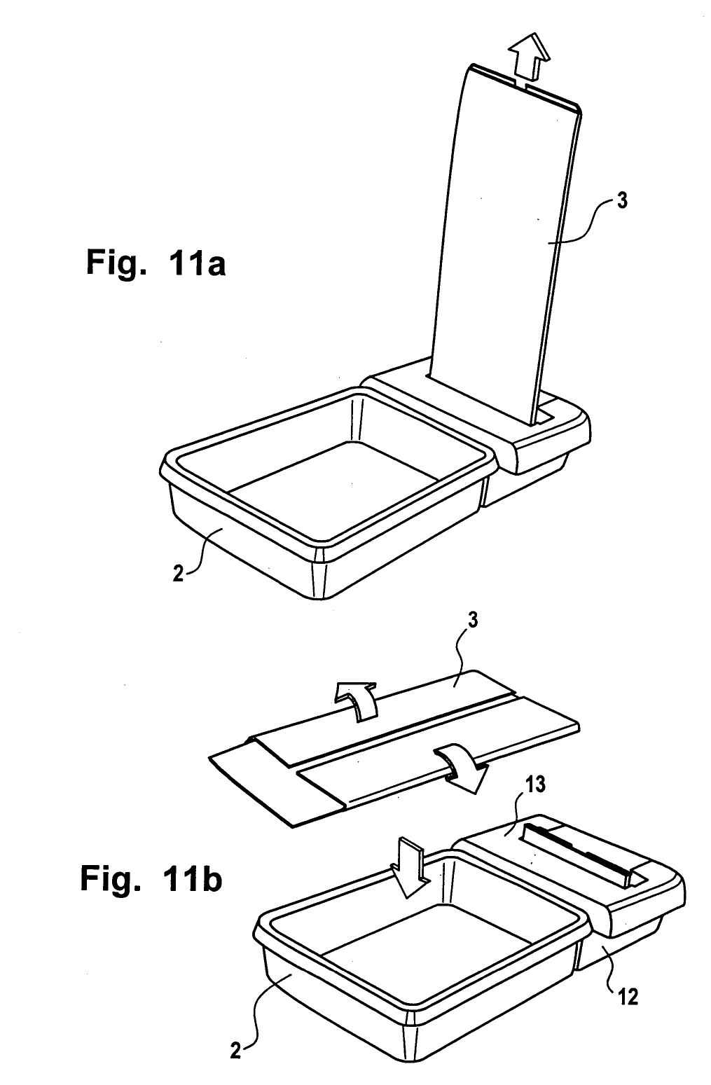

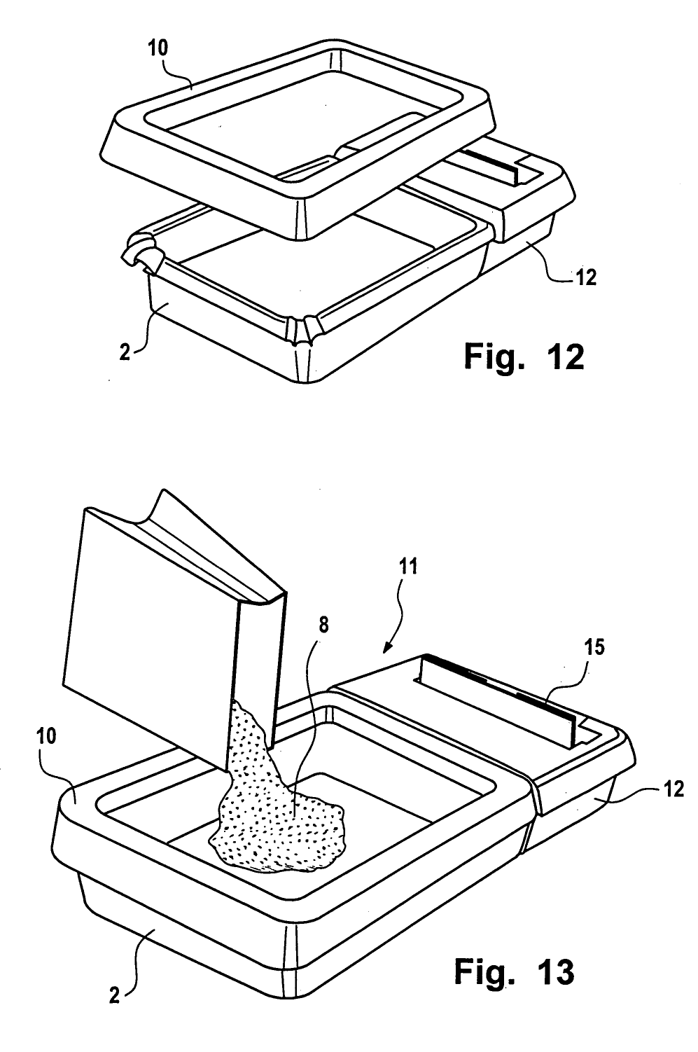

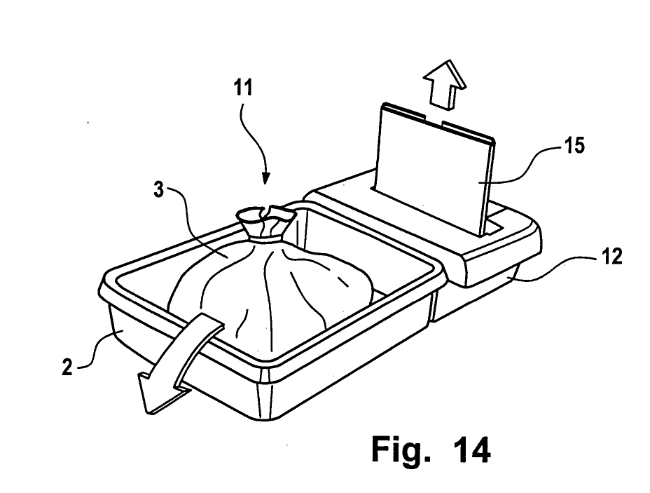

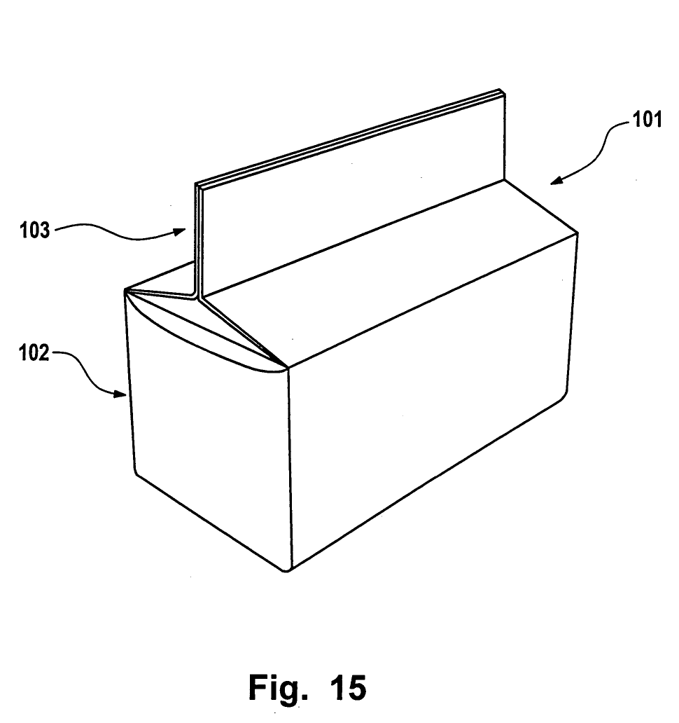

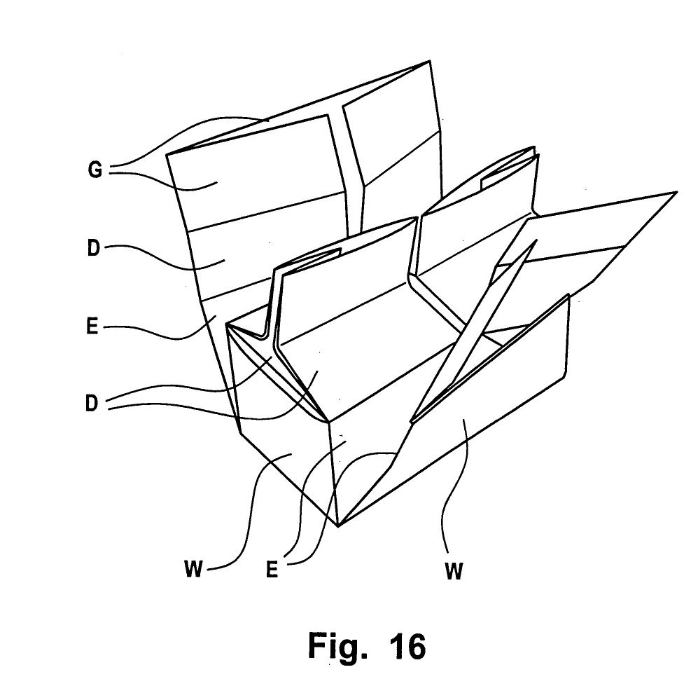

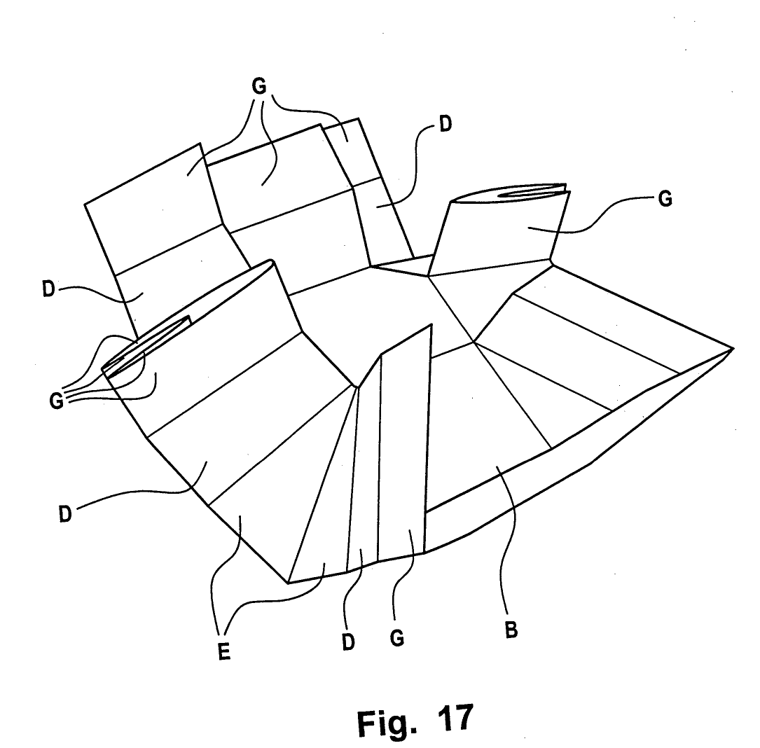

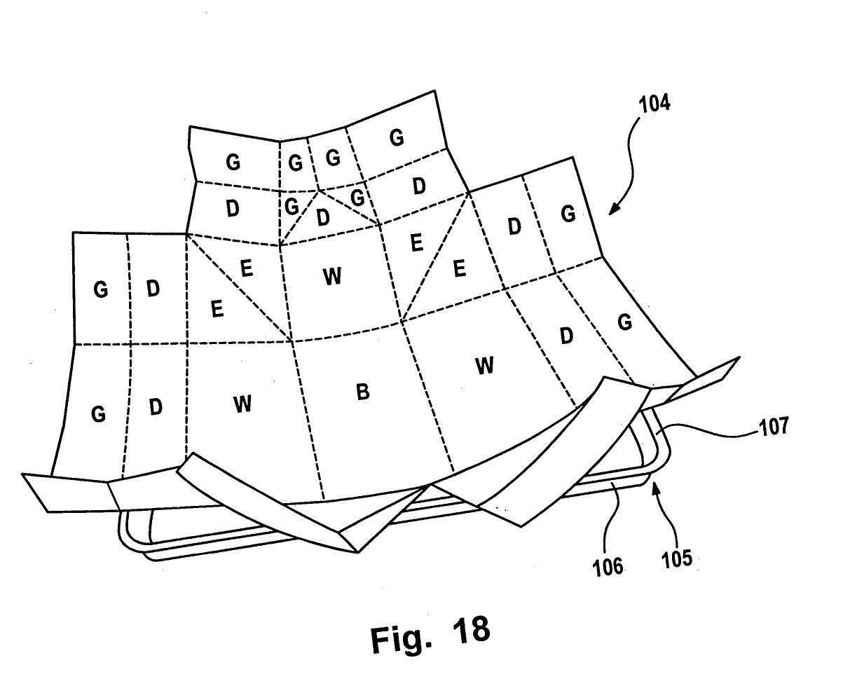

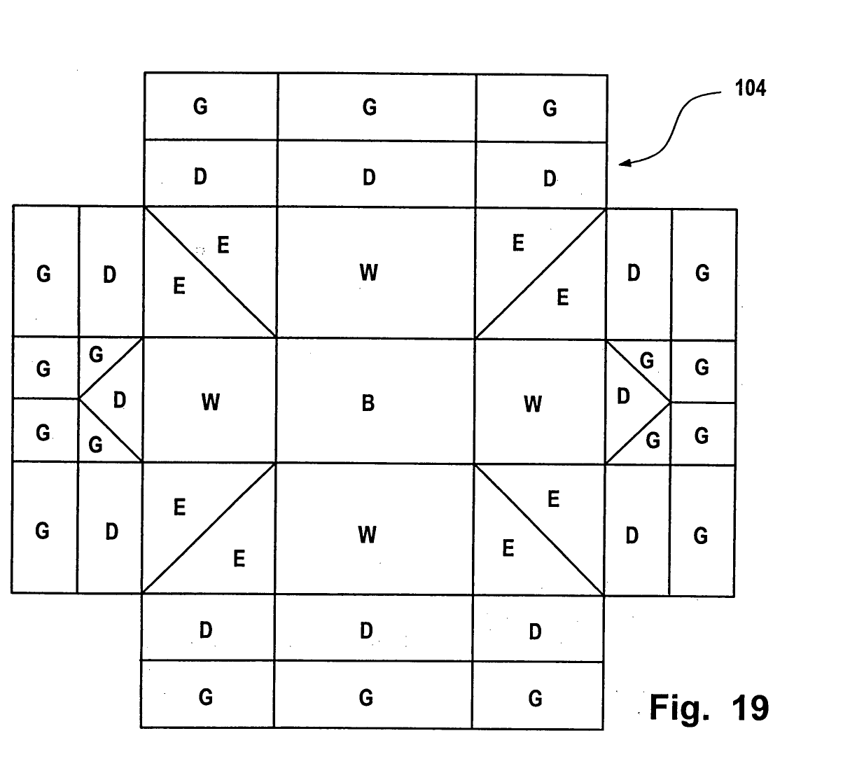

FIGS. 1a, 11b show perspective views illustrating how to insert a tubular bag into the cat lavatory of FIG. 10;

FIG. 12 shows a perspective view of the cat lavatory of FIG. 10 with the upper part in the state when it is lined with a tubular bag;

FIG. 13 shows a perspective view illustrating how to fill the cat lavatory shown in FIG. 10 with cat litter;

FIG. 14 shows a perspective view illustrating how to remove a tubular bag from the cat lavatory of FIG. 10;

FIG. 15 shows a perspective view illustrating a further embodiment of the invention with a folding pack in the folded-up state;

FIG. 16 shows the folding pack of FIG. 15 in a partially unfolded state;

FIG. 17 shows the folding pack in a more unfolded state;

FIG. 18 shows the folding pack in a substantially completely unfolded state and placed in a trough-like lower part of a cat lavatory, and

FIG. 19 shows a blank with fold lines to make a folding pack according to FIGS. 15-18.

### DETAILED DESCRIPTION OF THE INVENTION

FIG. 1 shows a first embodiment of a cat lavatory 1 of the invention, comprising a lower part 2 into which a tubular bag 3 can be inserted. On its transverse sides, the tubular bag 3 has broad edge portions 4 for lining the lateral peripheral edges of the lower part 2. Closure means 5, such as adhesive strips, are provided on the upper side of the tubular bag 3, and there is a longitudinal opening 6, such as a resealable adhesive seam, located centrally on the upper side of the tubular bag 3 and extending over the entire length of the tubular bag 3.

FIG. 2 shows a cross-section through a tubular bag 3 for use in the cat lavatory 1 of the invention. This tubular bag 3 is vacuum-sealed, which very much minimises the amount of space taken up by the tubular bag 3. The tubular bag 3, which can be made from a plastic film, such as polyethylene, comprises a lining layer of non-woven material 7 on its bottom inner side made of an extremely absorbent, odour-binding and scratch-proof material. The lining layer of non-woven material 7 is preferably 0.5 cm thick. A layer of litter 8, preferably 2 cm thick, is scattered on top of the lining layer of non-woven material.

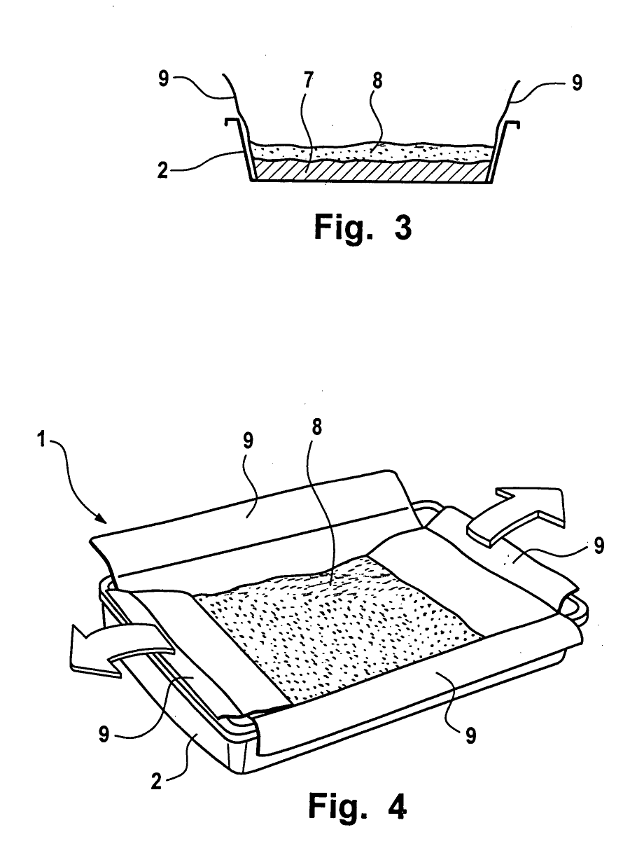

When the tubular bag 3 is opened, it is unfolded along the longitudinal opening 6, which is shown in FIG. 1, the end portions 9 of the tubular bag 3 being suitable for folding over the upper peripheral edge of the lower part 2, as is shown in FIGS. 3 and 4. When the tubular bag 3 is opened, air flows into the lining layer of non-woven material 7, so that this can result in a slight increase in its volume.

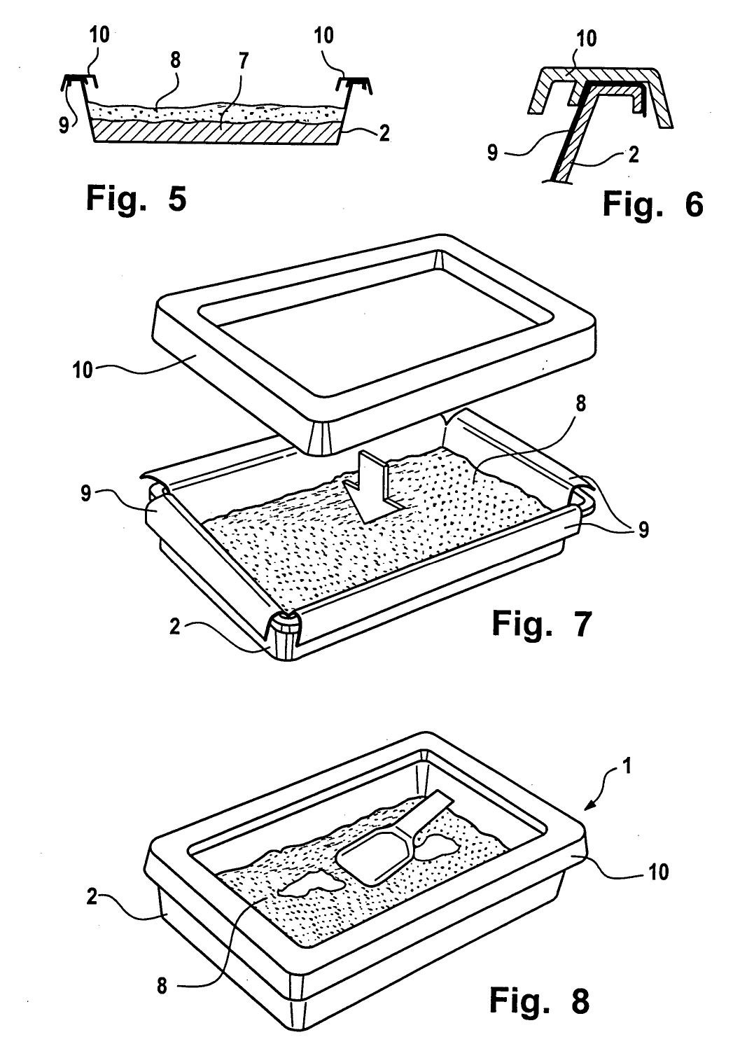

FIG. 5 shows the tubular bag 3 in its opened state inserted into the lower part 2, the end portions 9 of the tubular bag 3 having been folded over the upper peripheral edges of the lower part. The end portions 9 of the tubular bag 3 which have been folded over can be securely and stably attached to the circumferential walls of the lower part 2 in order to prevent the tubular bag 3 from slipping within the cat lavatory 1. Other possible methods of attachment, such as attachment by means of releasable adhesive strips and the like, will, however, be readily apparent to a man skilled in this art.

The attachment of the tubular bag 3 to the lower part 2 by means of the upper part 10 is shown in detail in FIG. 6. The upper part 10 preferably has the shape of a rectangular frame in this case, which can be placed over the lower part 2 and the end portions 9 of the tubular bag 3, as shown in FIG. 7.

A cat lavatory 1 fitted together completely is shown in FIG. 8. When the cat lavatory of the invention is used, soiled litter can be removed every day, the interior of the lining layer of non-woven material 7 immediately absorbing any moisture and binding both said moisture and any odours arising. Liquid can no longer escape from the lining layer of non-woven material 7.

The cat lavatory 1 of the invention provides reliable feline hygiene for at least one week.

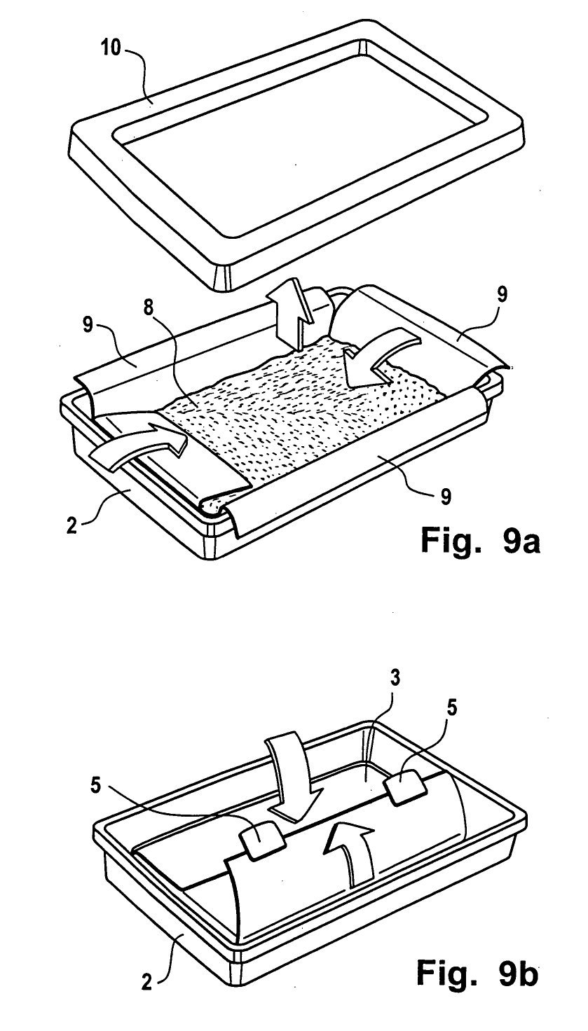

In order to replace the tubular bag 3 from the cat lavatory 1, the upper part 10 is first removed, then the end portions 9 of the tubular bag are folded inwards, and the tubular bag 3 is sealed again with the closure means 5, as illustrated in FIGS. 9a and 9b.

A tubular bag 3 sealed in this way can be simply disposed of without soiling the cat lavatory 1 or causing dust and odour problems.

FIG. 10 shows an exploded view of a second embodiment 11 of the cat lavatory of the invention. The cat lavatory according to FIG. 10 additionally comprises a storage box 12 with a cover 13 which has a removal opening 14. The storage box 12 can hold a number of tubular bags 3. In particular, it is conceivable for the tubular bags 3 to be separated from a supply roll 16 and removed individually by means of a tearing strip 15.

The removal of a tubular bag 3 from the supply roll 15 from the storage box 12 and the way it is placed in the lower part 2 are shown in FIGS. 11a and 11b. A tubular bag film of the appropriate length is torn off the roll and placed in the lower part 2 of the cat lavatory 11. The end portions 9 of the tubular bag 3 can again be securely attached to the lower part 2 by means of the upper part 10, as shown in FIG. 12. The cat lavatory prepared in this way can subsequently be lightly scattered with cat litter, whereby, compared to a conventional cat lavatory which only comprises cat litter, it is possible to reduce the amount of litter by 60 to 70 per cent by using the highly absorbent and odour-binding lining layer of non-woven material 7. FIG. 13 shows how litter 8 is scattered in.

FIG. 14 shows how the tubular bag 3 is removed from the cat lavatory 11, the upper part 10 having first been removed again. After that, the end portions 9 of the tubular bag 3 can be folded together and sealed with a closure means 5, in this case with a tape, for example, and the tubular bag 3 can be disposed of with no problem.

A further embodiment 111 of the cat lavatory of the invention will now be described with reference to FIGS. 15 to 19, where a lining layer of non-woven material (optionally covered in a tubular bag) and optionally additional litter material are placed in a folding pack.

FIG. 15 shows a folding pack indicated in its entirety by 101 in a closed state, in which it forms a dimensionally stable packaging container; it can be marketed in this form as a sales unit. The folding pack 101 has a substantially cuboid packaging body 102 with a handle portion extending upwards 103, the handle portion 103 being capable of being folded over horizontally for the purpose of stacking two or more folding packs 101 on top of one another. The folding pack 101 is made by folding, in a manner that will be explained, from a blank of a suitable material, which may be paper, paperboard, cardboard, plastic, some absorbent material or a composite material (e.g. painted cardboard or cardboard coated with plastic).

In order to explain the way in which the folding pack is made by being folded together from a blank of material, reference will now be made to FIG. 19, which shows a blank 104 of a suitable material. Inside the surface of the blank 104 there are a central floor portion B, wall portions W abutting it and corner portions E between adjacent wall portions W. Adjoining the wall and corner portions there are lid portions D on the outside, and adjoining these in turn are handle portions G. Between the various portions mentioned there are creases in each case, which are shown in FIG. 19 by solid lines.

FIG. 18 shows a perspective view of a blank 104 according to the invention, or an opened folding pack 101, the orientation having been rotated by 90° compared to FIG. 19. The opened folding pack is placed on a tray-like or trough-like lower part 105 of a cat lavatory, in which the four areas of the folding pack, which project laterally and form lid and handle portions D, G respectively, can in each case be folded over an edge 107 of the lower part 105, in order to attach them to the lower part to a certain extent. There can be provision for the basic area of the lower part 105 to correspond approximately to the area formed by the floor, wall and corner portions B, W, E of the folding pack, which is rectangular in this embodiment, so that the lateral areas, consisting of lid and handle portions respectively, run first of all upwards along the inner side walls 106 of the lower part and can then be folded sideways and outwards and down over the edge 107. A design of this kind is particularly convenient in connection with a frame-like top part of the cat lavatory, which can be removably placed on the lower part in such a manner that it extends over the side walls or the edge 107 together with the portions D, G of the folding pack folded over.

FIG. 17 shows the folding pack in an orientation rotated by about 45° compared to FIG. 18 and in a partially folded-up (or partially opened) state, in which not only the floor portion B, but in particular also the triangular corner portions E and the lid and handle portions D, G can be seen.

FIG. 16 shows a view corresponding to FIG. 17 in an even more folded-up state, which now also shows the walls W. As one can see, the folded-up corner portions E lie against the walls W, so that a substantially cuboid receptacle space for absorbent material is left in the interior of the folding pack 101.

As can also be seen from the drawings, the handle portion indicated in FIG. 15 by the numeral 103 is formed from handle portions G which overlap each other more than once, and which, in the embodiment shown, overlap each other six times and even eight times in the lateral edge regions, so that a stable handle portion capable of bearing loads is formed.

In the initial state as shown in FIG. 15, the folding pack may not only contain the lining layer of non-woven material but may also be filled with a certain amount of absorbent litter material, the quantity of which is chosen such that, in use (FIG. 18), there is a layer of litter material 1 to 3 cm thick over the base area (which preferably corresponds to the area B, W, E) corresponding to the lower part of the cat lavatory. In a preferred embodiment, the folding pack or the walls W is/are so high that the volume of the folding pack 1 is such that, when it is completely filled (in addition to the lining layer of non-woven material) it can hold a volume of litter material that corresponds to a layer 2 cm thick, for example, on the total base area of a cat lavatory formed by the portions B, W and E. The folding pack 101 can optionally be somewhat larger, in order to form a certain reserve, so that, after use, the used litter material can be held in the folding pack, once it has been folded up again, together with the faeces deposited by the cat.

There can be provision for the lining layer of non-woven material or the tubular bag in the initial state as shown in FIG. 15 to be folded together to a size that corresponds to the floor portion B and which is likewise unfolded when being opened into the position for use (FIG. 18).

After use, i.e. after a period of use that can be up to a week or more, depending on the absorptivity of the material used, the folding pack is folded up together with the lining layer of non-woven material and any litter material that may be present, and restored to a shape corresponding to FIG. 1, in which it can be disposed of simply and hygienically, and without causing dust. Since the handle and lid portions have not come into contact with litter material and/or cat faeces if, as is preferably the case in accordance with the invention, they have been folded over the edge of the cat lavatory, the disposal procedure can be effected extremely hygienically.

The features of the invention disclosed in the above description, in the drawings and in the claims may be essential for carrying out the invention in its various embodiments both individually and in any combination.

What is claimed is:

1. A cat lavatory (1, 11, 111) with a lower part (2) and a container (3) holding an absorbent material that can be inserted into the lower part (2), characterised in that the container (3) comprises a lining layer of non-woven material (7).

2. A cat lavatory as claimed in claim 1, characterised in that the lining layer of non-woven material (7) comprises a highly absorbent material.

3. A cat lavatory as claimed in either of claims 1 or 2, characterised in that the lining layer of non-woven material (7) comprises an odour-binding material.

4. A cat lavatory as claimed in any of the preceding claims, characterised in that the lining layer of non-woven material (7) is scratch-proof, at least on its upper surface.

5. A cat lavatory as claimed in any of the preceding claims, characterised in that the lining layer of non-woven material (7) has external dimensions corresponding substantially in shape to the internal dimensions of the lower part (2).

6. A cat lavatory as claimed in any of the preceding claims, characterised in that the lining layer of non-woven material (7) is between 0.1 and 1 cm thick, preferably 0.5 cm.

7. A cat lavatory as claimed in any of the preceding claims, characterised in that a layer of litter (8) is disposed on the lining layer of non-woven material (7).

8. A cat lavatory as claimed in claim 7, characterised in that the layer of litter (8) is between 1 and 3 cm, preferably 2 cm, thick.

9. A cat lavatory as claimed in any of the preceding claims, characterised in that the lower part (2) is in the shape of an open, rectangular bowl.

10. A cat lavatory as claimed in any of the preceding claims, characterised in that the container (3) can be opened in such a way that its top extremities (9) after it is placed in the lower part (2) can be folded out over the upper peripheral edge of the lower part (2) and, after the period of use is finished, folded together again for resealing.

11. A cat lavatory as claimed in claim 10, characterised in that the extremity (9) of the container (3) is attachable to the upper peripheral edge of the lower part (2).

12. A cat lavatory as claimed in either of claims 10 or 11, characterised by having an upper part (10) which can be removably placed on the lower part (2) after the extremities (9) of the container (3) have been folded out, said upper part (10) covering the upper peripheral edge of the lower part (2) and securing the folded out extremities (9) of the container (3) on the upper peripheral edge of the lower part (2).

13. A cat lavatory as claimed in claim 12, characterised in that the upper part (10) is designed in the form of a rectangular frame.

14. A cat lavatory as claimed in any of the preceding claims, characterised by having at least one closure means (5) for resealing the container (3) after use.

15. A cat lavatory as claimed in claim 14, characterised in that the closure means (5) comprises adhesive strips or a tape.

16. A cat lavatory as claimed in any of the preceding claims, characterised by having a separate storage box (12) for holding a number of containers (3).

17. A cat lavatory as claimed in claim 16, characterised by having a cover (13) on the storage box (12) with an opening (14) for removal.

18. A cat lavatory as claimed in any of the preceding claims, characterised in that the container is formed as a tubular bag (3).

19. A cat lavatory as claimed in claim 18, characterised in that the tubular bag (3) is vacuum-sealed prior to use.

20. A cat lavatory as claimed in either of claims 18 or 19, characterised in that the tubular bags (3) are provided in the form of a supply roll (15) in the storage box (12) and are separable by means of a tearing strip (16) and individually removable via a removal opening (14).

21. A cat lavatory as claimed in any of claims 1 to 17, characterised in that the container comprises a folding pack (101) which forms a dimensionally stable packaging container and can be folded apart for use.

22. A cat lavatory as claimed in claim 21, characterised in that the folding pack (101) is stackable.

23. A cat lavatory as claimed in either of claims 21 or 22, characterised in that the folding pack is substantially cuboid in shape.

24. A cat lavatory as claimed in any of claims 21, 22 or 23, characterised in that the folding pack is made from a blank (104) of paper, paperboard, cardboard, light plastic, composite material or some absorbent material which is planar in its initial condition.

25. A cat lavatory as claimed in any of claims 21 to 24, characterised in that the folding pack (101) has central, preferably substantially rectangular floor portion (B), against which wall portions (W) abut which are preferably rectangular.

26. A cat lavatory as claimed in claim 25, characterised in that corner portions (E) are disposed between adjacent wall portions (W).

27. A cat lavatory as claimed in claim 26, characterised in that the corner portions (E) rest against said wall portions (W) when folded up, so that a substantially cuboid receptacle space for absorbent material is formed.

28. A cat lavatory as claimed in either of claims 26 or 27, characterised in that lid portions (D) abut the wall or corner portions (W, E).

29. A cat lavatory as claimed in either of claims 26 or 27, characterised in that lid portions (D) abut both the wall portions (W) and the corner portions (E), so that the lid portions (D) overlap one another several times when folded up.

30. A cat lavatory as claimed in either of claims 28 or 29, characterised in that the lid portions (D) are substantially rectangular.

31. A cat lavatory as claimed in any of claims 28 to 30, characterised in that handle portions (G) abut the lid portions (D).

32. A cat lavatory as claimed in claim 31, characterised in that the handle portions (G) can be folded to lie flat on the lid portions (D).

33. A cat lavatory as claimed in either of claims 32 or 33, characterised in that the handle portions (G) are designed such that they overlap several times, especially four, six or eight times.
